(19) United States
(12) Patent Application Publication
(10) Pub. No.: US 2023/0395853 A1
(43) Pub. Date: Dec. 7, 2023

(54) ELECTROLYTE FOR LITHIUM SECONDARY BATTERIES

(71) Applicant: UMICORE, Brussels (BE)

(72) Inventors: Sebastian MAI, Ilmenau (DE); Svetlozar-Dimitrov IVANOV, Ilmenau (DE); Andreas BUND, Ilmenau (DE)

(21) Appl. No.: 18/249,606

(22) PCT Filed: Oct. 22, 2021
(86) PCT No.: PCT/EP2021/079322

§ 371 Date: Apr. 19, 2023

Related U.S. Application Data
(63) Continuation of application No. 17/078,448, filed on Oct. 23, 2020, now Pat. No. 11,322,779.

(30) Foreign Application Priority Data
Oct. 23, 2020 (EP) 20203655.4

(51) Int. Cl. H01M 10/0567; H01M 10/0568; H01M 4/505; H01M 4/38; H01M 10/052; H01M 4/525

(52) U.S. Cl. CPC H01M 10/0567; H01M 10/0568; H01M 4/505; H01M 4/382; H01M 10/052; H01M 4/525; H01M 2300/0025

(57) ABSTRACT

The present invention relates to an electrolyte composition suitable for lithium secondary batteries, comprising a specific lithium salt, preferably lithium bis(trifluoromethanesulfonyl)imide (LiTFSI), a fluorinated ether, preferably 1,1,2,2-tetrafluoroethyl-2,2,3,3-tetrafluoropropyl ether (TTE), a cyclic sulfone, preferably sulfolane (SL), and a fluorinated carbonate, preferably fluoroethylene carbonate (FEC), in an amount (x) of 0<x<=15 voL %, wherein the cyclic sulfone/lithium salt is comprised in a molar ratio (y) of 1.0<=y<=5.0 and the fluorinated ether/lithium salt is comprised in a molar ratio (z) of 1.0<=z<=5.0. The electrolyte according to the invention results in improved electrochemical properties.

### TECHNICAL FIELD

The present invention relates to an electrolyte composition for Li metal-based or lithium-ion batteries. In particular, the present invention relates to an electrolyte composition suitable for lithium secondary batteries, comprising a lithium salt, such as lithium bis(trifluoromethansolfonyl)imide (LiTFSI), a fluorinated solvent, such as 1,1,2,2-tetrafluoroethyl-2,2,3,3-tetrafluoropropyl ether (TTE), a cyclic sulfone, such as sulfolane (SL) and a fluorinated carbonate, such as fluoroethylene carbonate (FEC), as well as its application in a lithium secondary battery cell.

### BACKGROUND

The three primary functional components of a lithium-ion battery are the anode, the cathode, and the electrolyte. The anode of a conventional lithium-ion cell is made from carbon, the cathode of transition metal oxides such as cobalt, nickel, manganese, and the electrolyte is a non-aqueous solvent containing a lithium salt. Other lithium-ion batteries, e.g. based on lithium iron phosphates cathodes, are also present on the market.

The electrolyte should conduct lithium ions, acting as a carrier between the cathode and the anode when a battery passes an electric current through an external circuit. Electrolyte solvents in current use decompose on initial charging and form a solid interphase layer, which is electrically insulating, yet provides sufficient ionic conductivity. This interphase prevents further decomposition of the electrolyte in subsequent charge/discharge cycles.

Such electrolyte solvents typically consist of a mixture of organic carbonates such as ethylene carbonate (EC), di-methyl carbonate (DMC) and propylene carbonate (PC) and the lithium salt normally consists of a hexafluorophosphate, LiPF₆. WO 2019/211353 A1 relates to a non-aqueous liquid electrolyte composition suitable for secondary battery cells, especially lithium-ion secondary battery cells. Such electrolyte composition comprises a) at least one non-fluorinated cyclic carbonate and at least one fluorinated cyclic carbonate, b) at least one fluorinated acyclic carboxylic acid ester, c) at least one electrolyte salt, d) at least one lithium borate compound, e) at least one cyclic sulfur compound, and f) optionally at least one cyclic carboxylic acid anhydride, all components being present in specific proportions. It can advantageously be used in batteries comprising a cathode material comprising a lithium nickel manganese cobalt oxide (NMC) or a lithium cobalt oxide (LCO), especially at a high operating voltage.

As the market of lithium secondary batteries is rapidly expanding and there is an increasing demand for smaller and lighter batteries, which are suitable for portable electronic devices and which show tremendous energy densities, led to intensive developments attempting to achieve safe and stable batteries with higher capacities and which are able to operate at high operating voltages.

The capacity of a battery for portable electronic devices has currently reached a plateau mainly due to electrolyte stability limiting the operating voltage. The operating voltage of commercial batteries suitable for portable electronic devices currently varies from 4.2V to maximum 4.4V. For very high-end portable electronic devices such as leading-edge mobile phones, batteries applying operating voltages of at least 4.4V (and preferably not more than 4.5V) are requested. Moreover, some electrolyte compositions for secondary Lithium ion battery cells have safety issues, i.e. being inflammable.

It is therefore an object of the present invention to provide a stable, safe, and high energy density battery exhibiting good cycle life (which can be for instance sufficient to high or excellent cycle life) enabled through a high coulombic efficiency (i.e. of at least 93%, preferably of at least 98%), preferably at a higher voltage range i.e. at a voltage higher than 4.4 V) versus conventional cut-off or operating voltages (limited to 4.4 V).

It is an objective to provide a Li-ion battery having higher energy density. Selecting lithium metal as anode allows for higher energy density, but causes problems, amongst others problems with poor cyclability due to low coulombic efficiency. It is an objective of the present invention to provide a Li-ion battery having higher energy density which does not suffer from poor cyclability. This object has been solved by using an electrolyte composition comprising a lithium salt, a fluorinated solvent, a cyclic sulfone and a fluorinated carbonate, wherein the fluorinated carbonate is in an amount (x) of <x≤15 vol. %, wherein the cyclic sulfone/lithium salt is comprised in a molar ratio (y) of 1≤y≤5 and wherein the fluorinated solvent/lithium salt is comprised in a molar ratio (z) of 1≤z≤5. In particular, this object has been solved by using a sulfolane (SL)-based electrolyte composition suitable for lithium secondary batteries, comprising lithium bis(trifluoromethansolfonyl)imide (LiTFSI), 1,1,2,2-tetrafluoroethyl-2,2,3,3-tetrafluoropropyl ether (TTE), sulfolane (SL) and fluoroethylene carbonate (FEC) in an amount (x) of 0<x≤15 vol. %, wherein SL/LiTFSI is comprised in a molar ratio (y) of 1≤y≤5 and wherein TTE/LiTFSI is comprised in a molar ratio (z) of 1≤z≤5, wherein vol. % is defined as the volume of a specific constituent divided by the total volume of LiTFSI (M: 287.08 g/mol, ρ: 1.33 g/cm³), FEC (M: 106.05 g/mol, ρ: 1.45 g/cm³), and SL (M: 120.17 g/mol, ρ: 1.26 g/cm³), TTE (M: 232.07 g/mol; ρ: 1.54 g/cm³).

### DESCRIPTION OF THE FIGURES

FIG. 1: Experimental results on the relationship between cycling efficiency and varying molar ratios between sulfolane (SL) and a fixed molar ratio of 3.0:1.0 of 1,1,2,2-tetrafluoroethyl-2,2,3,3-tetrafluoropropyl ether (TTE) and lithium bis(trifluoromethansolfonyl)imide (LiTFSI) and at fixed 2.5 vol. % fluoroethylene carbonate (FEC) content.

FIG. 2: Experimental results on the relationship between cycling efficiency and varying vol. % of fluoroethylene carbonate (FEC) at a fixed molar ratio between sulfolane (SL), 1,1,2,2-tetrafluoroethyl-2,2,3,3-tetrafluoropropyl ether (TTE) and lithium bis(trifluoromethansolfonyl)imide (LiTFSI) of 3.0:3.0:1.0.

### DETAILED DESCRIPTION OF THE INVENTION

In a first aspect, the present invention relates to an electrolyte composition suitable for lithium secondary batteries, comprising
a lithium salt selected from group consisting of LiClO₄ (lithium perchlorate), LiN(SO₂F)₂ (lithium bis(fluorosulfonyl)imide), LiN(SO₂CF₃)₂(lithium bis(trifluoromethanesulfonyl)imide), LiN(SO₂C₂F₅)₂(lithium bis(pentafluoroethanesulfonyl)imide), LiNSO₂FSO₂CF₃ (lithium (fluorosulfonyl)(trifluoromethanesulfonyl)imide), LiN(SO₂)₂(CF₃)₃(lithium 1,1,2,2,3,3-hexafluoropropane-1,3-disulfonamide) and a combination thereof; preferably the lithium salt is LiN(SO₂C₂F₅)₂, LiN(SO₂CF₃)₂, LiN(SO₂F)₂ or LiN(SO₂)₂(CF₃)₃; most preferably the lithium salt is LiN(SO₂CF₃)₂;
a fluorinated solvent selected from the group consisting of 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2-trifluoroethyl ether (TFTFE), trifluoroethylhexafluoropropyl ether, tris(2,2,2-trifluoroethyl)orthoformate (TFEO), methoxynonafluorobutane (MOFB), ethoxynonafluorobutane (EOFB), tris(2,2,2-trifluoroethyl)orthoformate (TFEO), tris(hexafluoroisopropyl)orthoformate (THFiPO), tris(2,2-difluoroethyl)orthoformate (TDFEO), bis(2,2,2-trifluoroethyl) methyl orthoformate (BTFEMO), tris(2,2,3,3,3-pentafluoropropyl)orthoformate (TPFPO), tris(2,2,3,3-tetrafluoropropyl)orthoformate (TTPO) and a combination thereof; preferably the fluorinated solvent is selected from the group consisting of 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2-trifluoroethyl ether (TFTFE) and trifluoroethylhexafluoropropyl ether; most preferably the fluorinated solvent is 1,1,2,2-tetrafluoroethyl-2,2,3,3-tetrafluoropropyl ether (TTE);
a cyclic sulfone selected from the group consisting of sulfolane (SL), methylsulfolanes such as 3-methylsulfolane, 3,4-dimethylsulfolane, 2,4-dimethylsulfolane, trimethylene sulfone (thietane 1,1-dioxide), 1-methyl trimethylene sulfone, pentamethylene sulfone, hexamethylene sulfone, ethylene sulfone and a combination thereof; preferably the cyclic sulfone is sulfolane (SL), 3-methylsulfolane, 3,4-dimethylsulfolane or 2,4-dimethylsulfolane; most preferably the cyclic sulfone is sulfolane;
a fluorinated carbonate selected from the group consisting of 4-fluoro-1,3-dioxolan-2-one (fluoroethylene carbonate or FEC), cis or trans 4,5-difluoro-1,3-dioxolan-2-one, 4,4-difluoro-1,3-di-oxolan-2-one, 4-fluoro-5-methyl-1,3-dioxolan-2-one, methyl-2,2,2-trifluoroethyl carbonate (MTFEC), ethyl-2,2,2-trifluoroethyl carbonate (ETFEC), propyl-2,2,2-trifluoroethyl carbonate (PTFEC), methyl-2,2,2,2′,2′,2′-hexafluoro-i-propyl carbonate (MHFPC), ethyl-2,2,2,2′,2′,2′-hexafluoro-i-propyl carbonate (EHFPC), di-2,2,2-trifluoroethyl carbonate (DTFEC) and a combination thereof; preferably the fluorinated carbonate is 4-fluoro-1,3-dioxolan-2-one or 4-fluoro-5-methyl-1,3-dioxolan-2-one; most preferably the fluorinated carbonate is 4-fluoro-1,3-dioxolan-2-one.

For the sake of clarity, a skilled person is able to calculate the vol. % or volume percentage of each for the herein-described ingredients and molar ratios between each of the herein-described ingredients from the physical data available for each of the herein-described ingredients. For the sake of clarity, the vol. % or volume percentage is herein based on the total volume of the electrolyte composition unless stated otherwise.

In an embodiment the electrolyte composition further comprises the fluorinated carbonate in an amount (x) of 0<x≤15 vol. %, relative to the total volume of the composition. Depending on the respective amounts of the cyclic sulfone, the lithium salt and the fluorinated solvent in the composition, said electrolyte composition comprises the fluorinated carbonate in an amount (x′) of 0<x′≤13.4 wt. %, relative to the total weight of the composition.

Preferably, the fluorinated carbonate is present in amounts (x) of 0.1 vol. %≤x, 0.1 vol. %<x, 0.5 vol. %≤x, 0.5 vol. %<x, 1.0 vol. %≤x or 1.0 vol. %<x, relative to the total volume of the composition. Depending on the respective amounts of the cyclic sulfone, the lithium salt and the fluorinated solvent in the composition, said electrolyte composition corresponds to an electrolyte composition comprises the fluorinated carbonate in an amount (x′) of about 0.09 wt. %≤x′ or 0.09 wt. %<x′, 0.4 wt. %≤x′, 0.4 wt. %<x′, 0.9 wt. %≤x′ or 0.9 wt. %<x′, relative to the total weight of the composition.

Preferably, the fluorinated carbonate is present in amounts (x) of x≤15.0 vol. %, x<15.0 vol. %, x≤10.0 vol. %, x<10.0 vol. %, x≤5.0 vol. %, x<5.0 vol. %, x≤2.5 vol. % or x<2.5 vol. % or even x≤2.0 vol. %, x<2.0 vol. %, relative to the total volume of the composition. Depending on the respective amounts of the cyclic sulfone, the lithium salt and the fluorinated solvent in the composition, said electrolyte composition corresponds to an electrolyte composition comprising the fluorinated carbonate in an amount (x′) of about x′≤13.4 wt. %, x′<13.4 wt. %, x′≤8.8 wt. %, x′<8.8 wt. %, x′≤4.4 wt. % or x′<4.4 wt. %, x′≤2.2 wt. % or x′<2.2 wt. % or x′≤1.8 wt. % or x′<1.8 wt. %, relative to the total weight of the composition.

In an embodiment, the fluorinated carbonate is comprised in an amount (x) of 0.5 to 5.0 vol. %, relative to the total volume of the composition. Depending on the respective amounts of the cyclic sulfone, the lithium salt and the fluorinated solvent in the composition, said electrolyte composition corresponds to an electrolyte composition comprising the fluorinated carbonate in an amount (x′) of about 0.4 to about 4.4 wt. %, %, relative to the total weight of the composition. In a more preferred embodiment, the fluorinated carbonate is comprised in an amount (x) of 1.0 to 2.0 vol. %, corresponding to an amount (x′) of about 0.9 to about 1.8 wt. %.

In an embodiment, the electrolyte composition comprises the cyclic sulfone/lithium salt in a molar ratio (y) of 1.0≤y≤5.0. Preferably, the electrolyte composition comprises the cyclic sulfone/lithium salt in a molar ratio (y) of 1.0≤y, 1.0<y, 1.5≤y or 1.5<y. More preferably, the electrolyte composition comprises the cyclic sulfone/lithium salt in a molar ratio (y) of y≤5.0, y<5.0, y≤3.0, y<3.0, y≤2.5 or y<2.5. Even more preferably, the cyclic sulfone/lithium salt may be comprised in a molar ratio (y) of 1.0≤y≤5.0. In an even more preferred embodiment, the cyclic sulfone/lithium salt may be comprised in a molar ratio (y) of 1.0≤y≤3.0. In an even more preferred embodiment, the cyclic sulfone/lithium salt may be comprised in a molar ratio (y) of 1.5≤y≤2.5.

In an embodiment the electrolyte composition comprises the fluorinated solvent/lithium salt in a molar ratio (z) of 1.0≤z≤5.0. Preferably, the electrolyte composition comprises the fluorinated solvent/lithium salt comprised in a molar ratio (z) of 1.0<z, 2.0≤z, 2.0<z, 2.5≤z or 2.5<z. Preferably, the electrolyte composition comprises the fluorinated solvent/lithium salt comprised in a molar ratio (z) of z<5.0, z≤3.5, z<3.5, z≤3.0 or z<3.0. In a preferred embodiment, the fluorinated solvent/lithium salt may be comprised in a molar ratio (z) of 1<z<5.0. In a more preferred embodiment, the fluorinated solvent/lithium salt may be comprised in a molar ratio (z) of 2.0≤z≤3.5. In an even more preferred embodiment, the fluorinated solvent/lithium salt may be comprised in a molar ratio (z) of 2.5≤z≤3.0.

In a preferred embodiment, the electrolyte composition may comprise the fluorinated carbonate in an amount (x) of 0.1≤x≤10 vol. %, relative to the total volume of the composition. Depending on the respective amounts of the cyclic sulfone, the lithium salt and the fluorinated solvent in the composition, said electrolyte composition comprises the fluorinated carbonate in an amount (x′) of 0.09 to 8.8 wt. %, relative to the total weight of the composition, the cyclic sulfone/lithium salt in a molar ratio (y) of 1.0≤y<5.0 and the fluorinated solvent/lithium salt in a molar ratio (z) of 1.0<z<5.0.

In a particularly preferred embodiment, the electrolyte composition may comprise the fluorinated carbonate in an amount of 0.5 to 5 vol. %, relative to the total volume of the composition. Depending on the respective amounts of the cyclic sulfone, the lithium salt and the fluorinated solvent in the composition, said electrolyte composition comprises the fluorinated carbonate in an amount (x′) of 0.4 to 4.4 wt. %, relative to the total weight of the composition, the cyclic sulfone/lithium salt in a molar ratio (y) of 1.0≤y≤3.0 and the fluorinated solvent/lithium salt in a molar ratio (z) of 2.0≤z≤3.5.

In a particularly preferred embodiment, the electrolyte composition may comprise the fluorinated carbonate in an amount of 1.0 to 2.0 vol. %, relative to the total volume of the composition. Depending on the respective amounts of the cyclic sulfone, the lithium salt and the fluorinated solvent in the composition, said electrolyte composition comprises the fluorinated carbonate in an amount (x′) of 0.9 to 1.8 wt. %, relative to the total weight of the composition, and the cyclic sulfone/lithium salt in a molar ratio (y) of 1.5≤y≤2.5 and the fluorinated solvent/lithium salt in a molar ratio (z) of 2.5≤z≤3.0.

In a preferred embodiment, the electrolyte composition comprises the cyclic sulfone and the fluorinated solvent, whereby the cyclic sulfone and the fluorinated solvent are comprised in a molar ratio (y/z) of 2.0≤y/z≤3.0, preferably in a molar ratio (y/z) of 2.0≤y/z<3.0, and more preferably in a molar ratio (y/z) of 2.0≤y/z≤2.5.

In a preferred embodiment, the electrolyte composition comprises the lithium salt, the fluorinated solvent, the cyclic sulfone and the fluorinated carbonate in an amount of at least 90 vol. %, relative to the total volume of the composition, and more preferably in an amount of at least 95 vol. %, or even at least 99 vol. %. Most preferably said composition consists essentially of the lithium salt, the fluorinated solvent, the cyclic sulfone and the fluorinated carbonate.

In a highly preferred embodiment, the present invention relates to a sulfolane (SL)-based composition suitable for lithium secondary batteries, comprising LiN(SO₂CF₃)₂(LiTFSI or lithium bis(trifluoromethansolfonyl)imide), 1,1,2,2-tetrafluoroethyl-2,2,3,3-tetrafluoropropyl ether (TTE), sulfolane (SL) and 4-fluoro-1,3-dioxolan-2-one (FEC or fluoroethylene carbonate) in an amount (x) of 0<x≤15 vol. %.

Preferably, said sulfolane (SL)-based composition comprises LiTFSI and SL, wherein SL/LiTFSI is comprised in a molar ratio (y) of 1.0≤y≤5.0 and wherein TTE/LiTFSI is comprised in a molar ratio (z) of 1.0≤z≤5.0.

According to the present invention, the electrolyte composition comprises lithium bis(trifluoromethansolfonyl)imide (LiTFSI; LiN(SO₂CF₃)₂). LiTFSI is a well-known chemical compound (CAS: 90076-65-6).

According to the present invention, the electrolyte composition further comprises 4-fluoro-1,3-dioxolan-2-one (FEC or fluoroethylene carbonate) in an amount (x) of 0<x≤15 vol. %, relative to the total volume of the composition. Depending on the respective amounts of SL, LiTFSI and TTE in the composition, said electrolyte composition comprises FEC in an amount (x′) of 0<x′≤13.4 wt. %, relative to the total weight of the composition. FEC is a well-known chemical compound (CAS: 114435-02-8).

Preferably, FEC is present in amounts (x) of 0.1 vol. %≤x, 0.1 vol. %<x, 0.5 vol. %≤x, 0.5 vol. %<x, 1.0 vol. % x or 1.0 vol. %<x, relative to the total volume of the composition. Depending on the respective amounts of SL, LiTFSI and TTE in the composition, said electrolyte composition corresponds to an electrolyte composition comprising fluoroethylene carbonate (FEC) in an amount (x′) of about 0.09 wt. %≤x′ or 0.09 wt. %<x′, 0.4 wt. %≤x′, 0.4 wt. %<x′, 0.9 wt. %≤x′ or 0.9 wt. %<x′, relative to the total weight of the composition.

Preferably, FEC is present in amounts (x) of x≤15.0 vol. %, x<15.0 vol. %, x≤10.0 vol. %, x<10.0 vol. %, x≤5.0 vol. %, x<5.0 vol. %, x≤2.5 vol. % or x<2.5 vol. % or even x≤2.0 vol. %, x<2.0 vol. %, relative to the total volume of the composition. Depending on the respective amounts of SL, LiTFSI and TTE in the composition, said electrolyte composition corresponds to an electrolyte composition comprising fluoroethylene carbonate (FEC) in an amount (x′) of about x′ ≤13.4 wt. %, x′<13.4 wt. %, x′≤8.8 wt. %, x′<8.8 wt. %, x′≤4.4 wt. % or x′<4.4 wt. %, x′≤2.2 wt. % or x′<2.2 wt. % or x′≤1.8 wt. % or x′<1.8 wt. %, relative to the total weight of the composition.

In a preferred embodiment, FEC is comprised in an amount (x) of 0.5 to 5.0 vol. %, relative to the total volume of the composition. Depending on the respective amounts of SL, LiTFSI and TTE in the composition, said electrolyte composition corresponds to an electrolyte composition comprising fluoroethylene carbonate (FEC) in an amount (x′) of about 0.4 to about 4.4 wt. %, relative to the total weight of the composition. In a more preferred embodiment, FEC is comprised in an amount (x) of 1.0 to 2.0 vol. %, corresponding to an amount (x′) of about 0.9 to about 1.8 wt. %.

According to the present invention, the electrolyte composition further comprises sulfolane (SL). SL is a well-known chemical compound (CAS: 126-33-0).

According to the present invention, the electrolyte composition comprises SL/LiTFSI in a molar ratio (y) of 1.0≤y≤5.0.

Preferably, the electrolyte composition comprises SL/LiTFSI in a molar ratio (y) of 1.0≤y, 1.0<y, 1.5≤y or 1.5<y.

Preferably, the electrolyte composition comprises SL/LiTFSI in a molar ratio (y) of y≤5.0, y<5.0, y≤3.0, y<3.0, y≤2.5 or y<2.5.

In a preferred embodiment, SL/LiTFSI may be comprised in a molar ratio (y) of 1.0≤y≤5.0. In a more preferred embodiment, SL/LiTFSI may be comprised in a molar ratio (y) of 1.0≤y≤3.0. In an even more preferred embodiment, SL/LiTFSI may be comprised in a molar ratio (y) of 1.5≤y≤2.5.

According to the present invention, the electrolyte composition further comprises 1,1,2,2-tetrafluoroethyl-2,2,3,3-tetrafluoropropyl ether (TTE). TTE is a well-known chemical compound (CAS: 16627-68-2).

According to the present invention, the electrolyte composition comprises TTE/LiTFSI in a molar ratio (z) of 1.0≤z≤5.0.

Preferably, the electrolyte composition comprises TTE/LiTFSI comprising in a molar ratio (z) of 1.0<z, 2.0≤z, 2.0<z, 2.5≤z or 2.5<z.

Preferably, the electrolyte composition comprises TTE/LiTFSI comprising in a molar ratio (z) of z<5.0, z≤3.5, z<3.5, z≤3.0 or z<3.0.

In a preferred embodiment, TTE/LiTFSI may be comprised in a molar ratio (z) of 1<z<5.0. In a more preferred embodiment, TTE/LiTFSI may be comprised in a molar ratio (z) of 2.0≤z≤3.5. In an even more preferred embodiment, TTE/LiTFSI may be comprised in a molar ratio (z) of 2.5≤z≤3.0.

In a preferred embodiment, the electrolyte composition may comprise fluoroethylene carbonate (FEC) in an amount (x) of 0.1≤x≤10 vol. %, relative to the total volume of the composition. Depending on the respective amounts of SL, LiTFSI and TTE in the composition, said electrolyte composition comprises fluoroethylene carbonate (FEC) in an amount (x′) of 0.09 to 8.8 wt. %, relative to the total weight of the composition, SL/LiTFSI in a molar ratio (y) of 1.0≤y≤5.0 and TTE/LiTFSI in a molar ratio (z) of 1.0<z<5.0. In a particularly preferred embodiment, the electrolyte composition may comprise fluoroethylene carbonate (FEC) in an amount of 0.5 to 5 vol. %, relative to the total volume of the composition. Depending on the respective amounts of SL, LiTFSI and TTE in the composition, said electrolyte composition comprises fluoroethylene carbonate (FEC) in an amount (x′) of 0.4 to 4.4 wt. %, relative to the total weight of the composition, SL/LiTFSI in a molar ratio (y) of 1.0≤y≤3.0 and TTE/LiTFSI in a molar ratio (z) of 2.0≤z≤3.5.

In a particularly preferred embodiment, the electrolyte composition may comprise fluoroethylene carbonate (FEC) in an amount of 1.0 to 2.0 vol. %, relative to the total volume of the composition. Depending on the respective amounts of SL, LiTFSI and TTE in the composition, said electrolyte composition comprises fluoroethylene carbonate (FEC) in an amount (x′) of 0.9 to 1.8 wt. %, relative to the total weight of the composition, and SL/LiTFSI in a molar ratio (y) of 1.5≤y≤2.5 and TTE/LiTFSI in a molar ratio (z) of 2.5≤z≤3.0.

In a preferred embodiment, the electrolyte composition comprises sulfolane (SL) and TTE, whereby SL and TTE are comprised in a molar ratio (y/z) of 2.0≤y/z≤3.0, preferably in a molar ratio (y/z) of 2.0≤y/z<3.0, and more preferably in a molar ratio (y/z) of 2.0≤y/z≤2.5.

In a preferred embodiment, the electrolyte composition comprises LiTFSI, TTE, SL and FEC in an amount of at least 90 vol. %, relative to the total volume of the composition, and more preferably in an amount of at least 95 vol. %, or even at least 99 vol. %. Most preferably said composition consists essentially of LiTFSI, TTE, SL and FEC.

The way of preparing the electrolyte composition is not particularly limited, i.e. it can be for example prepared by mixing the ingredients.

The present invention also relates to a lithium secondary battery cell comprising the electrolyte composition according to the invention. For the sake of clarity, the lithium secondary battery cell comprises at least an anode, a cathode and an electrolyte, and optionally a separator. The electrolyte relates to the electrolyte according to the present invention described herein above.

The material of the cathode is not particularly limited, and examples thereof include a transition metal compound having a structure capable of diffusing lithium ions, or a specialized metal compound thereof and an oxide of lithium. Specifically, LiCoO₂, LiNiO₂, LiMn₂O₄, LiFePO₄, etc. can be mentioned. Preferred cathode materials are mixed metal oxides comprising lithium, nickel and optionally manganese, cobalt and/or aluminium.

The cathode can be formed by press-moulding the cathode material listed above together with a known conductive auxiliary agent or binder, or the positive electrode active material together with a known conductive auxiliary agent or binder into an organic solvent such as pyrrolidone. It can be obtained by applying a mixture and pasting it to a current collector such as an aluminium foil, followed by drying.

In a preferred embodiment, the cathode is a copper foil (cathode) vs lithium foil (anode).

The material of the anode is not particularly limited as long as it is a material capable of plating-stripping or inserting-extracting lithium. For example, any current collector, such as Cu, Ni or carbon based electrode, lithium metal, Sn—Cu, Sn—Co, Sn—Fe or Sn-An alloy such as —Ni, a metal oxide such as Li₄TisO₁₂ or Li₅Fe₂O₃, a natural graphite, an artificial graphite, a boronized graphite, a mesocarbon microbead, a carbon material such as a pitch-based carbon fiber graphitized material, carbon-Si composite or a carbon nanotube.

A separator is usually interposed between the cathode and the anode in order to prevent a short circuit between the cathode and the anode. The material and shape of the separator is not particularly limited, but it is preferable that the electrolyte composition can easily pass therethrough and that the separator is an insulator and a chemically stable material. Examples thereof include microporous films and sheets made of various polymer materials. Specific examples of the polymer material include polyolefin polymers, nitrocellulose, polyacrylonitrile, polyvinylidene fluoride, polyethylene, and polypropylene. From the viewpoints of electrochemical stability and chemical stability, polyolefin polymers are preferred.

In a preferred embodiment, the separator is a Polypropylene separator with a thickness of 40.0 μm and porosity of 48% (e.g. Cellguard 2075-1500M). Such a separator is described in the following article: International Journal of Electrochemistry, Volume 2018, Article ID 1925708, 7 pages, https://doi.org/10.1155/2018/1925708.

The optimum working voltage of the lithium secondary battery of the present invention is not particularly limited by the combination of the positive electrode and the negative electrode, but can be used at an average discharge voltage of 2.4 to 4.5 V. Preferably, the lithium secondary battery cell has a high operating voltage, i.e. an operating voltage superior or equal to 4.4 V and preferably inferior or equal to 4.5 V.

In a second aspect, the present invention relates to an electrochemical cell, comprising: a positive electrode; a negative electrode; and a liquid electrolyte comprising: the lithium salt according to the invention, the fluorinated solvent according to the invention, the cyclic sulfone according to the invention and the fluorinated carbonate according to the invention in an amount (x) of 0<x≤15 vol. %, whereby said electrochemical cell has a coulombic efficiency of at least 93%, measured by electro-plating 3.36 mAh/cm² of lithium on a negative electrode, preferably a copper foil, and electro-stripping 0.43 mAh/cm² of lithium from an amount of lithium electro-plated on said negative electrode, preferably said copper foil, and repeating the process at for 50 cycles, followed by a final electro-stripping step until the potential reaches +0.5 V. Preferably, said coulombic efficiency is at least 95%, more preferably at least 97% and most preferably at least 98%. Preferably, said current collector comprises a copper foil.

In a highly preferred embodiment the present invention relates to an electrochemical cell, comprising: a positive electrode; a negative electrode; and a liquid electrolyte comprising: lithium bis(trifluoromethansolfonyl)imide (LiTFSI; LiN(SO₂CF₃)₂), 1,1,2,2-tetrafluoroethyl-2,2,3,3-tetrafluoropropyl ether (TTE), sulfolane (SL), and fluoroethylene carbonate (FEC) in an amount (x) of 0<x≤15 vol. %, whereby said electrochemical cell has a coulombic efficiency of at least 93%, measured by electro-plating 3.36 mAh/cm² of lithium on a negative electrode, preferably a copper foil, and electro-stripping 0.43 mAh/cm² of lithium from an amount of lithium electro-plated on said negative electrode, preferably said copper foil, and repeating the process at for 50 cycles, followed by a final electro-stripping step until the potential reaches +0.5 V. Preferably, said coulombic efficiency is at least 95%, more preferably at least 97% and most preferably at least 98%. Preferably, said current collector comprises a copper foil.

In a preferred embodiment, the present invention provides an electrochemical cell according to the second aspect of the invention, said electrochemical cell comprising a liquid electrolyte according to the first aspect of the invention.

### EXAMPLES

1. Description of Coin Cell Preparations

Tested cells where coin cell types CR2025. The cells where prepared by stacking positive casing, positive electrode (pre-soaked in electrolyte), Cellguard-separator, 50 μL electrolyte droplet, negative electrode, spacer, wave-type spring and negative casing on top of each other in that order. Crimping was done with a manual crimping press from MTI corp. at 80 kg/cm² pressure.

The electrolyte composition is obtained by adding fluoroethylene carbonate (FEC) in an amount (x) of 0.0<x≤5.0 vol. % with respect to the total volume of the electrolyte, sulfolane (SL) and lithium bis(trifluoromethansolfonyl)imide (LiTFSI) in a SL/LiTFSI molar ratio (y) of 5.0 to 1.0 and 1,1,2,2-tetrafluoroethyl-2,2,3,3-tetrafluoropropyl ether (TTE) and LiTFSI in a SL/LiTFSI molar ratio (z) of 5.0 to 1.0.

2. Passivation Protocol

The passivation of the lithium samples was done by two steps. First, the cell described in the Section 1 above was constructed such that the cell was symmetric (Li metal is selected for both the anode and the cathode). Second, the cell was cycled 5 times with a current density of 0.60 mA/cm² for 2 hours per half cycle, resulting in a capacity of 1.20 mAh/cm². Afterwards the cells rested for 12 hours before being taken apart and the passivated Li electrodes comprising the SEI are extracted from the lithium cell.

3. Description of Methods for Measuring the Coulombic Efficiency

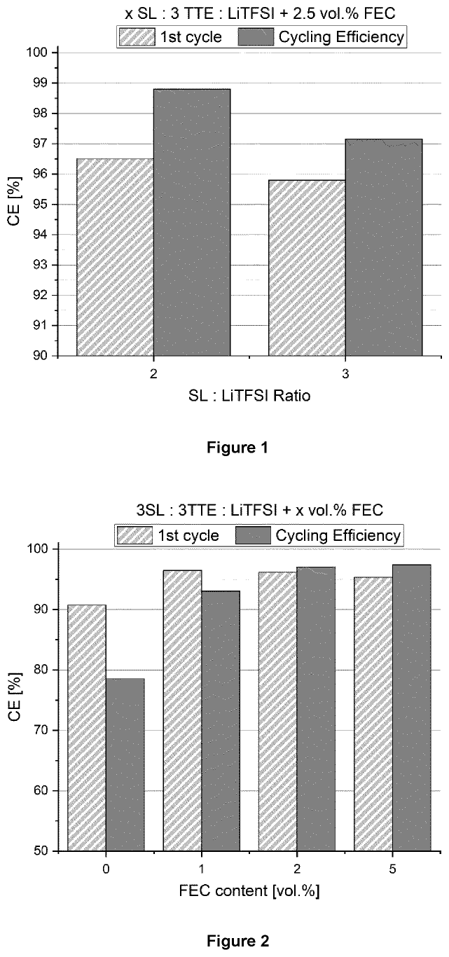

The coin cell including a passivated lithium electrode is charged and discharged several times under the following conditions to determine their charge-discharge cycle performances: the coulombic efficiency is measured with a Biologic VMP-3 potentiostat using a cell configuration consisting of a copper foil as cathode and a lithium foil as anode. Initially a certain amount of lithium metal (about 1 mg/50 μL of electrolyte corresponding to a capacity of 3.80 mAh) is plated on the copper foil using a constant current of 0.38 mA/cm² and subsequently completely removed by applying the inverse current up to the potential of 0.50 V, giving Q_{clean} which is used to calculate 1^{st} cycle efficiency in FIGS. 1 & 2 through CE₁ₛₜ=Q_{clean}/Qᵢₙᵢₜᵢₐₗ.

Subsequently another approximately 1 mg/50 μL of electrolyte of lithium metal corresponding to a capacity of 3.80 mAh (2^{nd} Qᵢₙᵢₜᵢₐₗ) is plated on the copper foil using the same current density.

After this, 50 cycles (n) with the current density of 0.380 mA/cm² and each cycle cycling 12.5% of the total (3.80 mAh, Qᵢₙᵢₜᵢₐₗ) capacity (0.475 mAh in our setup) where performed.

After the completion of the 50^{th} cycle, the remaining lithium was stripped away from the copper electrode by applying a current density of 0.380 mA/cm² to the cut-off voltage of 0.5 V (giving Q_{final}).

The CE was calculated using following general formula:

$$CE = \frac{n \cdot {Q}_{cycle} + {Q}_{final}}{n \cdot {Q}_{cycle} + {Q}_{initial}}$$

Based on the Q_{cycle}, Qᵢₙᵢₜᵢₐₗ, and n are known (see the description of experiment above) the formula can be simplified to

$$CE = \frac{23.75 mAh + {Q}_{final}}{27.55 mAh}$$

4. Experimental Tests and Results

For testing the relationship of the cycling efficiency to the molar ratio of sulfolane (SL):1,1,2,2-tetrafluoroethyl-2,2,3,3-tetrafluoropropyl ether (TTE):lithium bis(trifluoromethansolfonyl)imide (LiTFSI), the molar ratio was varied from 2:3:1 to 3:3:1. FEC content was kept constant at 2.5 vol. % and the coulombic efficiency was measured in the first charge and discharge cycle and in subsequent charge and discharge cycles. The experimental results are shown in FIG. 1.

FIG. 1 shows that the cycling efficiency of the electrolyte composition depends on the molar ratio of SL/LiTFSI.

The cycling efficiency of the electrolyte according to the invention having a molar ratio of SL/LiTFS from 2:1 shows a significantly high cycling efficiency of over 90%, and significantly higher when compared to an electrolyte according to the invention having a molar ratio of SL/LiTFSI from 3:1. In addition, also initial cycling efficiency is higher for the electrolyte having a molar ratio of SL/LiTFSI of 2:1.

The cycling efficiency of the electrolyte composition according to the invention having a molar ratio of SL/LiTFSI between 2.0 to 2.5 are optimum with a maximum at a molar ratio of SL/LiTFSI of 2.

The cycling efficiency of the electrolyte composition having a molar ratio of SL/LiTFSI of more than 3:1 did significantly decrease to a degree where it was unable to cycle.

For testing the dependency of the cycling efficiency to the amount of fluoroethylene carbonate (FEC), the amount of FEC (based on the volume percentage to the total volume of the electrolyte composition) was varied from 0 to 15 vol. % in steps of 1 vol. % while keeping the molar ratio of SL:TTE:TFSI constant at 3:3:1 and the coulombic efficiency was measured electrolyte in the first charge and discharge cycle and in subsequent charge and discharge cycles. The experimental results are shown in FIG. 2.

FIG. 2 shows that the cycling efficiency of the electrolyte composition depends on the amount of FEC added.

The cycling efficiency of the electrolyte according to the invention having a molar ratio of shows a significant high cycling efficiency of over 90%.

The cycling efficiency of the electrolyte composition according to the invention having 2 vol. %, 5 vol. % FEC has an optimum (the experimental results for the ranges up to 15 vol. % FEC are identical to 5 vol. % FEC and, thus, have been omitted for the sake of readability).

The cycling efficiency of the electrolyte composition having more than 15 vol. % FEC significantly dropped and lead to unstable lithium plating behaviour and cell failure.

The results depicted in FIGS. 1 and 2 are summarized in Tables 1 and 2 below:

TABLE 1
Impact of molar ratio of SL/LiTFSI on the Coulombic efficiency.

| SL/ LITFSI | 1^{st} cycle CE (%) | CE (%) |
|---|---|---|
| 2.0 | 96.5 | 98.8 |
| 3.0 | 95.8 | 97.2 |

TABLE 2
Impact of FEC content on Coulombic efficiency.

| FEC vol. % | 1^{st} cycle CE (%) | CE (%) |
|---|---|---|
| 0.0 | 90.8 | 78.5 |
| 1.0 | 96.4 | 93.1 |
| 2.0 | 96.2 | 97.1 |
| 5.0 | 95.4 | 97.4 |

1-20. (canceled)

21. An electrolyte composition suitable for lithium secondary batteries, comprising:
a lithium salt selected from group consisting of LiClO₄, LiN(SO₂F)₂, LiN(SO₂CF₃)₂, LiN(SO₂C₂F₅)₂, LiNSO₂FSO₂CF₃, LiN(SO₂)₂(CF₃)₃ and a combination thereof;
a fluorinated solvent selected from the group consisting of 1,1,2,2-tetrafluoroethyl-2,2,3,3-tetrafluoropropyl ether, bis(2,2,2-trifluoroethyl) ether, 1,1,2,2-tetrafluoroethyl-2,2,2-trifluoroethyl ether, trifluoroethylhexafluoropropyl ether, tris(2,2,2-trifluoroethyl)orthoformate, methoxynonafluorobutane, ethoxynonafluorobutane, tris(2,2,2-trifluoroethyl)orthoformate, tris(hexafluoroisopropyl)orthoformate, tris(2,2-difluoroethyl)orthoformate, bis(2,2,2-trifluoroethyl) methyl orthoformate, tris(2,2,3,3,3-pentafluoropropyl)orthoformate, tris(2,2,3,3-tetrafluoropropyl)orthoformate and a combination thereof;
a cyclic sulfone selected from the group consisting of sulfolane, methylsulfolanes such as 3-methylsulfolane, 3,4-dimethylsulfolane, 2,4-dimethylsulfolane, trimethylene sulfone, 1-methyl trimethylene sulfone, pentamethylene sulfone, hexamethylene sulfone, ethylene sulfone and a combination thereof; and
a fluorinated carbonate selected from the group consisting of 4-fluoro-1,3-dioxolan-2-one (fluoroethylene carbonate or FEC), cis or trans 4,5-difluoro-1,3-dioxolan-2-one, 4,4-difluoro-1,3-di-oxolan-2-one, 4-fluoro-5-methyl-1,3-dioxolan-2-one, methyl-2,2,2-trifluoroethyl carbonate (MTFEC), ethyl-2,2,2-trifluoroethyl carbonate (ETFEC), propyl-2,2,2-trifluoroethyl carbonate (PTFEC), methyl-2,2,2,2′,2′,2′-hexafluoro-i-propyl carbonate (MHFPC), ethyl-2,2,2,2′,2′,2′-hexafluoro-i-propyl carbonate (EHFPC), di-2,2,2-trifluoroethyl carbonate (DTFEC) and a combination thereof;
wherein the fluorinated carbonate is in an amount (x) of 0<x≤15 vol. %,
wherein the cyclic sulfone/lithium salt is comprised in a molar ratio (y) of 1.0≤y≤5.0, and
wherein the fluorinated solvent/lithium salt is comprised in a molar ratio (z) of 1.0≤z≤5.0.

22. The electrolyte composition according to claim 21, wherein the lithium salt is LiN(SO₂C₂F₅)₂, LiN(SO₂CF₃)₂, LiN(SO₂F)₂ or LiN(SO₂)₂(CF₃)₃.

23. The electrolyte composition according to claim 21, wherein the fluorinated solvent is selected from the group consisting of 1,1,2,2-tetrafluoroethyl-2,2,3,3-tetrafluoropropyl ether, bis(2,2,2-trifluoroethyl) ether, 1,1,2,2-tetrafluoroethyl-2,2,2-trifluoroethyl ether and trifluoroethylhexafluoropropyl ether.

24. The electrolyte composition according to claim 21, wherein the cyclic sulfone is sulfolane (SL), 3-methylsulfolane, 3,4-dimethylsulfolane or 2,4-dimethylsulfolane.

25. The electrolyte composition according to claim 21, wherein the fluorinated carbonate is 4-fluoro-1,3-dioxolan-2-one (FEC) or 4-fluoro-5-methyl-1,3-dioxolan-2-one.

26. The electrolyte composition according to claim 21, wherein:
the lithium salt is LiN(SO₂CF₃)₂,
the fluorinated solvent is 1,1,2,2-tetrafluoroethyl-2,2,3,3-tetrafluoropropyl ether (TTE),
the cyclic sulfane is sulfolane (SL), and
the fluorinated carbonate is 4-fluoro-1,3-dioxolan-2-one (FEC) in an amount (x) of 0<x≤15 vol. %,
wherein SL/LiTFSI is comprised in a molar ratio (y) of 1.0≤y≤5.0, and
wherein TTE/LiTFSI is comprised in a molar ratio (z) of 1.0≤z≤5.0.

27. The electrolyte composition according to claim 21, wherein the fluorinated carbonate is comprised in an amount (x) of 0.1≤x≤10 vol. %.

28. The electrolyte composition according to claim 21, wherein the fluorinated carbonate is comprised in an amount of 0.5 to 5 vol. %.

29. The electrolyte composition according to claim 21, wherein the fluorinated carbonate is comprised in an amount of 1.0 to 2.0 vol. %.

30. The electrolyte composition according to claim 21, wherein the cyclic sulfone/lithium salt is comprised in a molar ratio (y) of 1.0≤y<5.0.

31. The electrolyte composition according to claim 21, wherein the cyclic sulfone/lithium salt is comprised in a molar ratio (y) of 1.0≤y≤3.0.

32. The electrolyte composition according to claim 21, wherein the cyclic sulfone/lithium salt is comprised in a molar ratio (y) of 1.5≤y≤2.5.

33. The electrolyte composition according to claim 21, wherein the fluorinated solvent/lithium salt is comprised in a molar ratio (z) of 1.0<z<5.0.

34. The electrolyte composition according to claim 21, wherein the fluorinated solvent/lithium salt is comprised in a molar ratio (z) of 2.0≤z≤3.5.

35. The electrolyte composition according to claim 21, wherein the fluorinated solvent/lithium salt is comprised in a molar ratio (z) of 2.5≤z≤3.0.

36. The electrolyte composition according to claim 21, wherein the cyclic sulfone and the fluorinated solvent are comprised in a molar ratio SL/TTE (y/z) of 2.0≤y/z≤3.0.

37. A lithium secondary battery cell comprising the electrolyte composition according to claim 21.

38. The lithium secondary battery cell according to claim 37, wherein said battery cell has a coulombic efficiency of at least 93%, measured by electro-plating 3.36 mAh/cm² of lithium on a negative electrode and electro-stripping 0.43 mAh/cm² of lithium from an amount of lithium electro-plated on said negative electrode and repeating the process at for 50 cycles, followed by a final electro-stripping step until the potential reaches +0.5 V.

39. The lithium secondary battery cell according to claim 38, wherein said coulombic efficiency is at least 95%.

40. The lithium secondary battery cell according to claim 39, wherein said coulombic efficiency is at least 98%.
